(19) United States
(12) Patent Application Publication
(10) Pub. No.: US 2024/0152922 A1
(43) Pub. Date: May 9, 2024

(54) SYSTEM AND METHOD FOR GEOLOCATION AUTHENTICATION FOR MULTIPLE PARTIES

(71) Applicant: Better Collective USA, Inc., New York, NY (US)

(72) Inventors: Brandon Cohen, New York, NY (US); Daniel Hood, Marina del Rey, CA (US); Justyn Laufenberg, Stoughton, WI (US)

(21) Appl. No.: 18/500,286

(22) Filed: Nov. 2, 2023

Related U.S. Application Data
(60) Provisional application No. 63/382,170, filed on Nov. 3, 2022.

(51) Int. Cl. G06Q 20/40

(52) U.S. Cl. CPC G06Q 20/40155

(57) ABSTRACT

Systems, methods, and computer-readable storage media for verifying geolocation of a user, and more specifically to verifying geolocation of the user for marketplace aggregator when parties listed on the marketplace aggregator have differing geolocation requirements. A system can receive available transactions from third party computing systems, such as sportsbooks, where the available transactions require location verification. The system can display the available transactions, and the user can select one or more of those transactions. The system can then execute location verification of the user, and initiate, after receiving the verified location, communications between the system and the third party computing system, the communications enabling fulfillment of the selection.

### PRIORITY

This application claims priority to U.S. Provisional Patent Application No. 63/382,170, filed Nov. 3, 2022, the contents of which are incorporated herein in their entirety.

### BACKGROUND

### 1. Technical Field

The present disclosure relates to verifying geolocation of a user, and more specifically to verifying geolocation of the user for marketplace aggregator when parties listed on the marketplace aggregator have differing geolocation requirements.

### 2. Introduction

Different jurisdictions have different laws and regulations, such that the geolocation of a user needs to be verified prior to permitting actions which may be restricted in some locations.

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computing device, a plurality of available transactions from third party computing systems, wherein the plurality of available transactions require location verification; displaying, via a display of the computing device, the plurality of available transactions; receiving, at the computing device, a selection of an available transaction within the plurality of available transactions, the available transaction offered by a third party computing system within the third party computing systems; executing, via at least one processor of the computing device, location verification of the computing device, resulting in a verified location; and initiating, after receiving the verified location and via the at least one processor, communications between the computing device and the third party computing system, the communications enabling fulfillment of the selection.

A system configured to perform the concepts disclosed herein can include: a display; at least one processor; and a non-transitory computer-readable storage medium having instructions stored which, when executed by the at least one processor, cause the at least one processor to perform operations comprising: receiving a plurality of available transactions from third party computing systems, wherein the plurality of available transactions require location verification; displaying, via the display, the plurality of available transactions; receiving a selection of an available transaction within the plurality of available transactions, the available transaction offered by a third party computing system within the third party computing systems; executing location verification of a computing device, resulting in a verified location; and initiating, after receiving the verified location, communications between the computing device and the third party computing system, the communications enabling fulfillment of the selection.

A non-transitory computer-readable storage medium configured as disclosed herein can have instructions stored which, when executed by at least one processor, cause the at least one processor to perform operations which include: receiving a plurality of available transactions from third party computing systems, wherein the plurality of available transactions require location verification; displaying, via a display, the plurality of available transactions; receiving a selection of an available transaction within the plurality of available transactions, the available transaction offered by a third party computing system within the third party computing systems; executing location verification of a computing device, resulting in a verified location; and initiating, after receiving the verified location, communications between the computing device and the third party computing system, the communications enabling fulfillment of the selection.

### BRIEF DESCRIPTION OF THE DRAWINGS

FIG. 1 illustrates an example of the system for confirming credentials, verifying location, and completing a transaction;

FIG. 2 illustrates an example of a hybrid geo-location verification system;

FIG. 3 illustrates an example method embodiment; and

FIG. 4 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Systems configured as disclosed herein facilitate the act of purchasing, authorizing, or otherwise facilitating a transaction from a marketplace aggregator where confirming the user's physical location is required as a precondition to the purchase. A user of the system disclosed herein can, for example browse available transactions of third parties through a computing device (such as a desktop, laptop, smartphone, tablet computer, smartwatch, etc.) accessing a marketplace hosted by a website or other software application. The user can then complete a purchase or authorize one or more of the available transactions without having to leave the marketplace, thereby minimizing the need to send traffic (e.g., data) from the marketplace to a third party.

Certain purchase transactions (such as making an online bet) may require a user to be in a specific location to complete such transactions due to regulatory requirements. Whereas previously only certain vendors had the technological capability to determine a user's exact location, the system disclosed herein allows for transaction purchases or authorizations to take place on a third-party aggregator website (e.g., the marketplace) the necessity of exiting the aggregator website to the primary vendor's website to determine the user's location.

The system can, for example, allow a user to view transactions available for purchase/authorization in the user's current location (e.g., all available transactions at that location, or a subset of available transactions), and can further allow the user to complete the purchase/authorization on the aggregator site, whereas other solutions require a user to browse all available transactions on the aggregator site and then transfer to the vendor's site in order to complete the purchase.

To verify the user's location, the system can utilize third party location verification systems, proprietary location verification, and/or device-enabled systems (such as, but not limited to, GPS (Global Positioning System) coordinates of the computing device being used, cell tower triangulation, etc.). For example, in some configurations, the system can first use the proprietary location verification which is built into the system, and that can allow the system to display the available transactions for a user in that location. Once the user has identified a transaction they would like to purchase, then the system can engage the third party location verification system, resulting in a multi-tiered location verification, which can then be used to enable the transaction. In other configurations, the system can use only one of those systems (e.g., only the proprietary location verification built into the system, or only the third party location verification system) or can use additional location verification means.

For example, in some configurations, the system can use a hybrid location verification system. A hybrid location verification system can use a progressive combination of a behavioral verification system, Internet Protocol (IP)-based location services system, and third-party location verification systems. Each step happens in successive fashion. For the user to initiate the betting process, the system starts by checking the users' declared betting location (i.e., the state or province they are located in) and analyzing the user's behavior and movement patterns, such as the consistency of the stated location over time. After analyzing and confirming this user submitted information, the system cross-verifies the user location with an internal IP-based verification system, which is not user-submitted. This process occurs automatically upon confirming the user submitted information, and acts as a verifiable check. If these two locations do not match, the process ends, and the user is told that they must re-check their location with the system to proceed. Once the user provided location and the internal IP-based verification locations match, the process continues. After the internal IP-based verification check is passed, the system can then cross-verify the results with a trusted third-party location verification system. If these final two systems (i.e., the third-party location verification system and the sports betting operator system) agree on the user's location the process continues to the bet placement verification steps.

At this point, the two platforms (the sportsbook aggregator and the sports betting operator(s)) can achieve a shared user session and effectively become paired. The shared session is established by an API that normalizes the user data between the two disparate user management systems. This API is responsible for securely sharing unique identifiers across the platforms without exposing personal account details. This process involves a secure exchange of information between the 3rd party app (i.e., the sportsbook aggregator) and the sports betting operator app. Specifically, the platforms exchange shared information including unique identifiers (for example, user IDs), transaction data (for example, wager details—bet amount, market IDs, event IDs), and/or session-related data (timestamp). Unique identifiers can be used to match the user's account on both platforms. Transaction data can be shared to facilitate wager placement. Wager information can be received (at the 3^{rd} party app from the betting operator) and then processed through a mapping system to match the operator's IDs to the internal IDs used in the 3^{rd} party system. The mapping system analyzes team names, player names, partial team names, partial player names, event dates, etc., to match to the most relevant events/players/teams between the two platforms.

Firewalled information, which is not shared between the two platforms, can include personal account details, such as sensitive user credentials (e.g., login credentials or financial information). This information is strictly firewalled off, and such details are not exposed during this process.

The shared data is then normalized and confirmed. The normalization process involves converting and structuring the shared data from both platforms into a common format. For example, different data representations on each platform are harmonized so they can be effectively utilized. Normalization ensures that data can be seamlessly used on both sides, despite potential differences in the data's native format. The confirmation process includes verifying the integrity and accuracy of the shared data. It ensures that the data shared from both platforms is consistent and reliable, and that the data aligns with the user's account. Any discrepancies or errors are flagged and resolved during this stage to maintain data accuracy.

Once the data is normalized and confirmed, the system then creates a virtualized or simulated instance of the sports betting operators app on the 3^{rd} party app. The underlying code operates on the user device, primarily within the 3^{rd} party app, utilizing an API to communicate with the sports betting operator. Preferably, the 3^{rd} party app provides the interface and initial functionality for the user. The code and logic within the 3^{rd} party app facilitate the interaction with the sports betting operator app or system. The sports betting operator app, which is the second platform, also plays a significant role in the process. The sports betting operator app allows access to a secure co-built API necessary to interact with the 3^{rd} party app, then also validates user information, and authorizes wager placement. A “proprietary API” that normalizes and secures the shared data may involve code elements from both the 3^{rd} party app system and the sports betting operator system. It's a shared solution designed to work seamlessly between the two platforms. This API ensures the secure exchange of data while adhering to data privacy and security standards.

The combined efforts of both platforms and the shared API result in the successful execution of the user session, secure data exchange, and creation of the virtualized sports betting operator instance within the 3^{rd} party app's interface. The objective is to provide users with a seamless and secure way to place wagers while ensuring data privacy and user account security.

With this shared session and virtualized instance, the user is able to access his or her account at the sports betting operator remotely, through the 3rd party app's interface, and place wagers on the sports betting operator account. This virtualized instance offers a technical solution that provides a new level of convenience and security for users trying to place sports wagers.

In some configurations, whenever a user interacts with the hybrid location system, their location data is securely recorded. This data can include specific location, timestamp, and additional contextual information. When a user initiates the bet placement flow and starts with the location verification process, the system can cross-verify the most recent location data (based on timestamp) with the user's current location as an initial check. If this check is satisfied, the user is able to proceed to the second step of the hybrid location test.

The system can also vary how/when the location verification occurs within the transaction processes based on the requirements of specific third party vendors. For example, in some configurations, the system may require location verification just to sign into the system, and that location can then be used for any of the third party vendors whose products are being shared in the marketplace (without additional location verification). In other configurations, third party vendors may require the location be verified before seeing the possible transactions, whereas other third party vendors may not require location verification until the user selects a transaction for purchase. Likewise, in some configurations, the third party vendor may require that the location verification occur as each transaction is being purchased (e.g., when the bet is being placed). In yet other configurations, once a location has been verified there may have a time period where the verified location is considered valid (e.g., the location would be considered verified for five minutes, then would need to be reconfirmed). In yet other configurations, the system may have a variable time period for the location to be considered valid based on proximity to other jurisdictions. For example, if the user is currently in Colorado and is more than sixty miles (96.5 km) from a border, the system may consider the location verified for an hour, whereas if the user were ten miles (16 km) from a border, the system may only consider the user verified for ten minutes. In yet other configurations, the verification may be valid so long as the user continues to interact with the system and/or the third party. And in some configurations, the location verification received for interacting with one third party may be valid for a second third party.

Systems configured as disclosed herein do not store or save any PII (Personal Identifiable Information). Instead, if the user needs to input third party account information for particular vendors whose content is listed on the aggregator website (e.g., a particular vendor's platform, a particular sportsbook, a particular casino, an online betting platform), the system can initiate the request to the third party for the login page. The user can then directly input their login information into the third party page, and that information can bypass the current system. In some configurations, the system may allow their computing device (such as their smartphone) to store login information for the third party login page, allowing the user to access the third party site upon the user's device executing a user verification. Such allowance can be granted, for example, by the delivery of a token (e.g., an alphanumerical sequence/key) which grants the user access for a predetermined about of time. In other configurations, the third party may outsource authentication to other parties, and the system can use an API (Application Programming Interface) or other mechanisms to obtain an access token, certification, or other confirmation of authentication from those other parties. For example, a user may be registered with an oAuth (Open Authorization) login method (e.g., they use their FACEBOOK, GOOGLE, or other third party services to log into the vendor's platform), such that the system will log in with that service in order to get an authorization token (as opposed to transmitting a completed login form). In yet other configurations, the system can use other mechanisms or configurations to verify the identify the user and authenticate their account with the third party.

Once the third party has received the login information (e.g., a username/password) or other tokens/certifications/biometric data which can be used to authenticate the user, the third party can verify the user has an account with the third party and that the transaction can occur. For example, the third party can transmit, back to the system, a verification code, thumbs up, or other indication that the user account is valid. In some configurations, the user may need to maintain a balance with the third party. In such configurations, the third party may only allow transactions to occur when the user's account is sufficiently funded. Likewise, the third party may send an indication to the system requesting that the user provide additional funds, where the additional funding may or may not be processed through the system.

In some configurations, the system can have “state-aware session rules.” For example, the system may recognize the specific regulations and session length rules imposed by each state, province, or other jurisdiction where sports betting apps operate. By integrating the varying legal requirements into the system, once user location is verified, the system only “keeps alive” the user session for the legally mandated and allowed time. Further, the system can display a visible countdown timer within the app used on a user's mobile device, the countdown timer indicating the remaining time in the user's current session. This timer can be adjusted automatically based on the state's rules in which the user is located. Following the end of the allowable session length, the user is auto-logged out until they return to authorize their location.

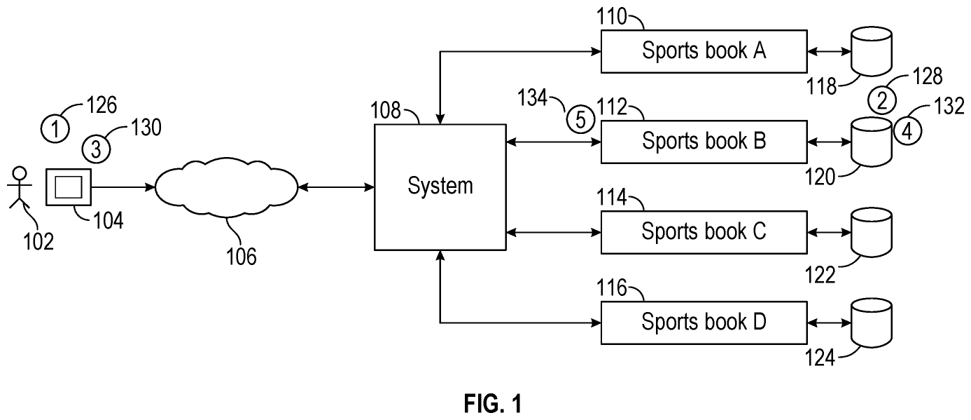

FIG. 1 illustrates an example of the system for confirming credentials, verifying location, and completing a transaction. As illustrated, a user 102 is interacting with a system 108 via a mobile computing device 104 (such as a cell phone, smartphone, tablet, laptop, or other computing device), with the mobile computing device 104 communicating with the system 108 through a network 106 (such as the Internet). The system 108 illustrated is one or more servers running the third-party aggregator website described above, where data from various sportsbooks 110, 112, 114, 116 is combined together and made available to the user 102. Each sportsbook 110, 112, 114, 116 has a database 118, 120, 122, 124 storing data about credentialed users, available bets, etc.

As illustrated, the user 102 (1) 126 finds a bet on the mobile computing device 104. For example, the user 102 can tap a button on the mobile computing device 104 indicating they wish to place a bet, setting off a series of behind the scenes communications between the sportsbook which will authorize the bet and the system 108. In the illustrated example, the sportsbook which will authorize the bet is Sportsbook B 112. At this point the user 102 enters their credentials with Sportsbook B 112 into their mobile device 104, the credentials are sent to the system 108, and the system 108 securely sends the credentials to Sportsbook B 112 for verification. The system 108 does not review or analyze the credentials before passing them on to Sportsbook B 112, and only repackages and forwards the credentials. Sportsbook B 112 then (2) 128 verifies the user's credentials through their API (Application Programming Interface) being shared with the system 108, allowing the user the ability to place the bet with the system 108.

Post-login, location verification of the user's mobile device 104 begins (3) 130. The location verification data is sent from the user's mobile device 104 to the system 108, and only at that point does the “Place Bet” button become active. If the location verification fails, the user will be unable to place the wager with the sportsbook.

After the user presses “Place Bet,” the system 108 sends the sportsbook 112 the bet amount and the odds via a shared API. The sportsbook 112 (4) 132 verifies the odds are still correct, and that the user 102 has enough funds to make the bet. If the user 102 does not have enough money, they'll be directed to the sportsbook 112 from the system 108 to make a deposit. Once the sportsbook 112 confirms the odds and the availability of the funds, the wager is placed at the sportsbook 112 through the book's API. The sportsbook handles the funds related to the transaction, and passes back (5) 134 a confirmation to the system 108 that the wager was successfully placed, along with a bet identification number or other identifier. This confirmation can then be presented to the user 102 via the mobile computing device 104.

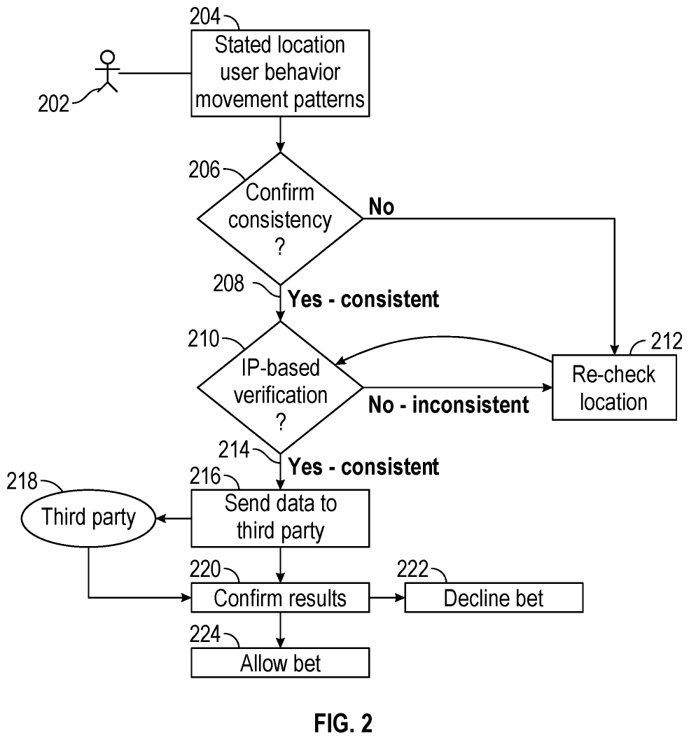

FIG. 2 illustrates an example of a hybrid geo-location verification system. In this example, a user 202 provides data to a system, the data including one or more of: a stated location, user behavior, and/or movement patterns. The stated location can be, for example, a state/province, a city, a zip code or postal zone, and/or GPS (Global Positioning System) coordinates. The user behavior can be, for example, data regarding betting habits after the user's last location confirmation (e.g., Did the user make a series of bets which would have been illegal in a nearby location? Did the user change location after being denied a betting opportunity (indicating an understanding that the location was not allowed). The movement patterns can be, for example, the movement patterns of the user over the past few hours (e.g., 3-5 hours), or movement patterns of the user over a previously defined period of time (e.g., hour or weeks). This data is, preferably, in the form of GPS coordinates or another precise form of location information. Using that data 204, the system confirms 206 if the user's stated location and the movement patterns/user behavior provide a level of consistency. If not, the system re-check's the user location 212, preferably using the GPS coordinates of the user's mobile device and/or IP (Internet Protocol) address information. If the system confirms 208 that the user's stated location and the movement patterns/user behavior meet a predetermined level of consistency, the system can perform an IP-based verification 210, confirming that the IP addresses used in the internet traffic to send the system the data 204 matches known IP addresses for computing systems in the stated geographic area. If yes 214, the system then sends 216 the data 204 to a third party 218. The third party 218 can provide a location of the user 202, and the system, based on the third party 218 results and the previously determined location obtained through the in-house process (steps 206, 208, 210, 212), and confirm if the third-party results match the in-house results. If so, the system can allow the bet 224, whereas if not the system can decline the bet 222.

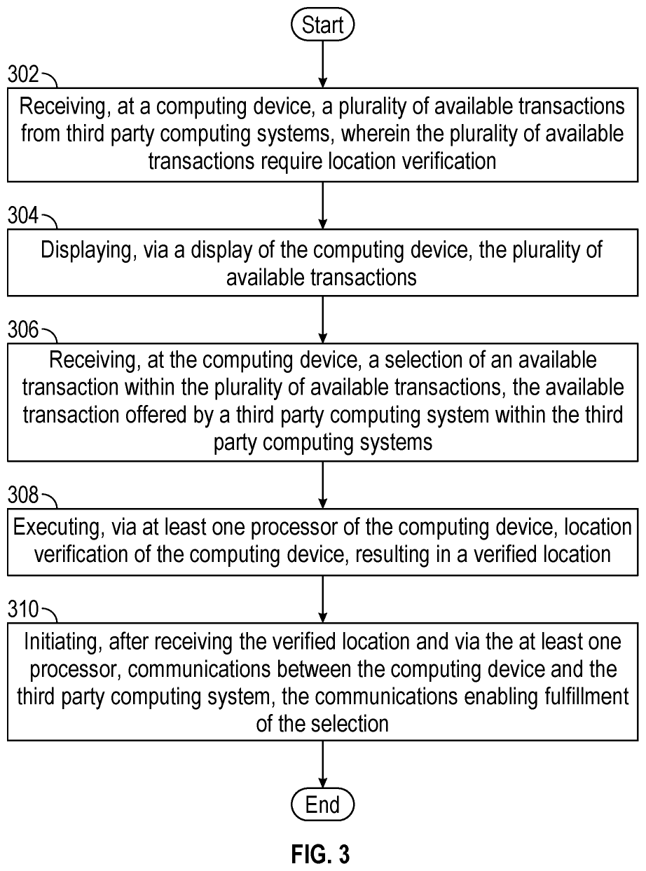

FIG. 3 illustrates an example method embodiment. As illustrated, a system can receive, at a computing device, a plurality of available transactions from third party computing systems (such as from various sportsbooks), wherein the plurality of available transactions require location verification (302), and display, via a display of the computing device, the plurality of available transactions (304). The system can then receive, at the computing device, a selection of an available transaction within the plurality of available transactions, the available transaction offered by a third party computing system within the third party computing systems (306), and execute, via at least one processor of the computing device, location verification of the computing device, resulting in a verified location (308). The system can then initiate, after receiving the verified location and via the at least one processor, communications between the computing device and the third party computing system, the communications enabling fulfillment of the selection (310).

In some configurations, the illustrated method can further include: transmitting, from the computing device to the third party computing system, a request to log a user into the third party computing system; receiving, at the computing device via an API (Application Programming Interface) associated with the third party computing system, a login form; transmitting, from the computing device to the third party computing system, a completed login form; and receiving, at the computing device from the third party computing system, a token authorizing transactions on behalf of the user. In such configurations, the account verification can be required prior to the displaying of the plurality of available transactions. Likewise, in such configurations, the account verification can be required prior to the executing of the location verification. In some such configurations, the executing of the location verification can occur prior to the receiving of the plurality of available transactions.

In some configurations, the location verification can include use of a location verification algorithm executed by the computing device.

In some configurations, the location verification can include use of a third party location verification provider.

In some configurations, the plurality of available transactions can include available wagers, and the third party computing systems can be online betting platforms.

In some configurations, the illustrated method can further include: transmitting, from the computing device to a third party authorization provider, a request to log a user into the third party computing system; receiving, at the computing device via an API (Application Programming Interface) associated with the third party authorization provider, a login form; transmitting, from the computing device to the third party authorization provider, a completed login form; and receiving, at the computing device from the third party authorization provider, a token authorizing transactions with the third party computing system on behalf of the user.

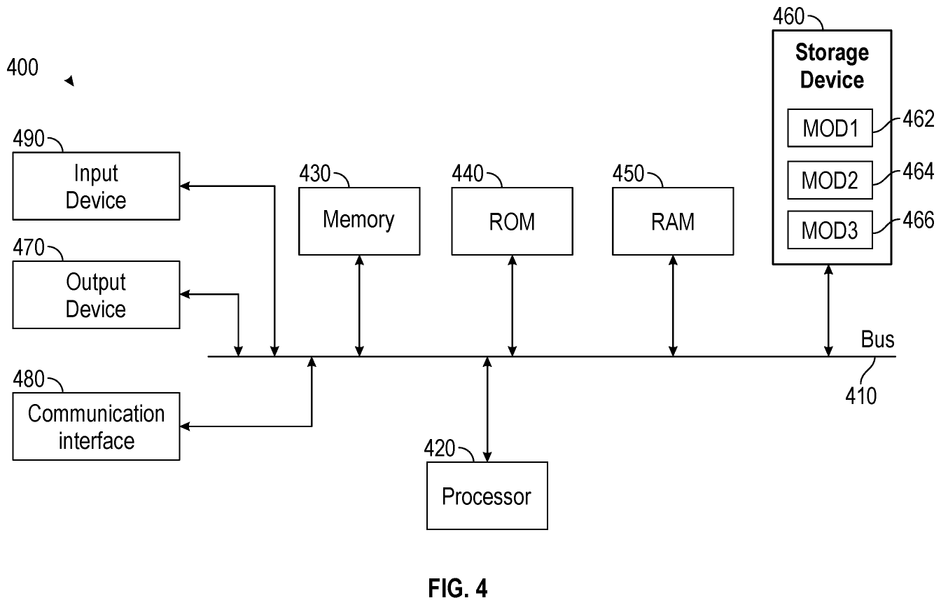

With reference to FIG. 4, an exemplary system includes a general-purpose computing device 400, including a processing unit (CPU or processor) 420 and a system bus 410 that couples various system components including the system memory 430 such as read-only memory (ROM) 440 and random-access memory (RAM) 450 to the processor 420. The system 400 can include a cache of high-speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general-purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computing device, a plurality of available transactions from third party computing systems, wherein the plurality of available transactions require location verification; displaying, via a display of the computing device, the plurality of available transactions; receiving, at the computing device, a selection of an available transaction within the plurality of available transactions, the available transaction offered by a third party computing system within the third party computing systems; executing, via at least one processor of the computing device, location verification of the computing device, resulting in a verified location; and initiating, after receiving the verified location and via the at least one processor, communications between the computing device and the third party computing system, the communications enabling fulfillment of the selection.

The method of any preceding clause, further comprising: transmitting, from the computing device to the third party computing system, a request to log a user into the third party computing system; receiving, at the computing device via an API (Application Programming Interface) associated with the third party computing system, a login form; transmitting, from the computing device to the third party computing system, a completed login form; and receiving, at the computing device from the third party computing system, a token authorizing transactions on behalf of the user.

The method any preceding clause, wherein account verification is required prior to the displaying of the plurality of available transactions.

The method any preceding clause, wherein account verification is required prior to the executing of the location verification.

The method any preceding clause, wherein the executing of the location verification occurs prior to the receiving of the plurality of available transactions.

The method any preceding clause, wherein the location verification comprises use of a location verification algorithm executed by the computing device.

The method any preceding clause, wherein the location verification comprises use of a third party location verification provider.

The method any preceding clause, wherein the plurality of available transactions are available wagers, and the third party computing systems are online betting platforms.

The method any preceding clause, further comprising: transmitting, from the computing device to a third party authorization provider, a request to log a user into the third party computing system; receiving, at the computing device via an API (Application Programming Interface) associated with the third party authorization provider, a login form; transmitting, from the computing device to the third party authorization provider, a completed login form; and receiving, at the computing device from the third party authorization provider, a token authorizing transactions with the third party computing system on behalf of the user.

A system comprising: a display; at least one processor; and a non-transitory computer-readable storage medium having instructions stored which, when executed by the at least one processor, cause the at least one processor to perform operations comprising: receiving a plurality of available transactions from third party computing systems, wherein the plurality of available transactions require location verification; displaying, via the display, the plurality of available transactions; receiving a selection of an available transaction within the plurality of available transactions, the available transaction offered by a third party computing system within the third party computing systems; executing location verification of a computing device, resulting in a verified location; and initiating, after receiving the verified location, communications between the computing device and the third party computing system, the communications enabling fulfillment of the selection.

The system any preceding clause, the non-transitory computer-readable storage medium having additional instructions stored which, when executed by the at least one processor, cause the at least one processor to perform operations comprising: transmitting, to the third party computing system, a request to log a user into the third party computing system; receiving, via an API (Application Programming Interface) associated with the third party computing system, a login form; transmitting, to the third party computing system, a completed login form; and receiving, from the third party computing system, a token authorizing transactions on behalf of the user.

The system any preceding clause, wherein account verification is required prior to the displaying of the plurality of available transactions.

The system any preceding clause, wherein account verification is required prior to the executing of the location verification.

The system any preceding clause, wherein the executing of the location verification occurs prior to the receiving of the plurality of available transactions.

The system any preceding clause, wherein the location verification comprises use of a location verification algorithm executed by the at least one processor.

The system any preceding clause, wherein the location verification comprises use of a third party location verification provider.

The system any preceding clause, wherein the plurality of available transactions are available wagers, and the third party computing systems are online betting platforms.

The system any preceding clause, the non-transitory computer-readable storage medium having additional instructions stored which, when executed by the at least one processor, cause the at least one processor to perform operations comprising: transmitting, to a third party authorization provider, a request to log a user into the third party computing system; receiving, at a computing device via an API (Application Programming Interface) associated with the third party authorization provider, a login form; transmitting, to the third party authorization provider, a completed login form; and receiving, from the third party authorization provider, a token authorizing transactions with the third party computing system on behalf of the user.

A non-transitory computer-readable storage medium having instructions stored which, when executed by at least one processor, cause at least one processor to perform operations comprising: receiving a plurality of available transactions from third party computing systems, wherein the plurality of available transactions require location verification; displaying, via a display, the plurality of available transactions; receiving a selection of an available transaction within the plurality of available transactions, the available transaction offered by a third party computing system within the third party computing systems; executing location verification of a computing device, resulting in a verified location; and initiating, after receiving the verified location, communications between the computing device and the third party computing system, the communications enabling fulfillment of the selection.

The non-transitory computer-readable storage medium any preceding clause, having additional instructions stored which, when executed by at least one processor, cause the at least one processor to perform operations comprising: transmitting, to the third party computing system, a request to log a user into the third party computing system; receiving, via an API (Application Programming Interface) associated with the third party computing system, a login form; transmitting, to the third party computing system, a completed login form; and receiving, from the third party computing system, a token authorizing transactions on behalf of the user.

We claim:

1. A method comprising:
receiving, at a computing device, a plurality of available transactions from third party computing systems, wherein the plurality of available transactions require location verification;
displaying, via a display of the computing device, the plurality of available transactions;
receiving, at the computing device, a selection of an available transaction within the plurality of available transactions, the available transaction offered by a third party computing system within the third party computing systems;
executing, via at least one processor of the computing device, location verification of the computing device, resulting in a verified location; and
initiating, after receiving the verified location and via the at least one processor, communications between the computing device and the third party computing system, the communications enabling fulfillment of the selection.

2. The method of claim 1, further comprising:
transmitting, from the computing device to the third party computing system, a request to log a user into the third party computing system;
receiving, at the computing device via an API (Application Programming Interface) associated with the third party computing system, a login form;
transmitting, from the computing device to the third party computing system, a completed login form; and
receiving, at the computing device from the third party computing system, a token authorizing transactions on behalf of the user.

3. The method of claim 2, wherein account verification is required prior to the displaying of the plurality of available transactions.

4. The method of claim 2, wherein account verification is required prior to the executing of the location verification.

5. The method of claim 2, wherein the executing of the location verification occurs prior to the receiving of the plurality of available transactions.

6. The method of claim 1, wherein the location verification comprises use of a location verification algorithm executed by the computing device.

7. The method of claim 1, wherein the location verification comprises use of a third party location verification provider.

8. The method of claim 1, wherein the plurality of available transactions are available wagers, and the third party computing systems are online betting platforms.

9. The method of claim 1, further comprising:
transmitting, from the computing device to a third party authorization provider, a request to log a user into the third party computing system;
receiving, at the computing device via an API (Application Programming Interface) associated with the third party authorization provider, a login form;
transmitting, from the computing device to the third party authorization provider, a completed login form; and
receiving, at the computing device from the third party authorization provider, a token authorizing transactions with the third party computing system on behalf of the user.

10. A system comprising:
a display;
at least one processor; and
a non-transitory computer-readable storage medium having instructions stored which, when executed by the at least one processor, cause the at least one processor to perform operations comprising:
receiving a plurality of available transactions from third party computing systems, wherein the plurality of available transactions require location verification;
displaying, via the display, the plurality of available transactions;
receiving a selection of an available transaction within the plurality of available transactions, the available transaction offered by a third party computing system within the third party computing systems;
executing location verification of a computing device, resulting in a verified location; and
initiating, after receiving the verified location, communications between the computing device and the third party computing system, the communications enabling fulfillment of the selection.

11. The system of claim 10, the non-transitory computer-readable storage medium having additional instructions stored which, when executed by the at least one processor, cause the at least one processor to perform operations comprising:
transmitting, to the third party computing system, a request to log a user into the third party computing system;
receiving, via an API (Application Programming Interface) associated with the third party computing system, a login form;
transmitting, to the third party computing system, a completed login form; and
receiving, from the third party computing system, a token authorizing transactions on behalf of the user.

12. The system of claim 11, wherein account verification is required prior to the displaying of the plurality of available transactions.

13. The system of claim 11, wherein account verification is required prior to the executing of the location verification.

14. The system of claim 11, wherein the executing of the location verification occurs prior to the receiving of the plurality of available transactions.

15. The system of claim 10, wherein the location verification comprises use of a location verification algorithm executed by the at least one processor.

16. The system of claim 10, wherein the location verification comprises use of a third party location verification provider.

17. The system of claim 10, wherein the plurality of available transactions are available wagers, and the third party computing systems are online betting platforms.

18. The system of claim 10, the non-transitory computer-readable storage medium having additional instructions stored which, when executed by the at least one processor, cause the at least one processor to perform operations comprising:
transmitting, to a third party authorization provider, a request to log a user into the third party computing system;
receiving, at a computing device via an API (Application Programming Interface) associated with the third party authorization provider, a login form;
transmitting, to the third party authorization provider, a completed login form; and
receiving, from the third party authorization provider, a token authorizing transactions with the third party computing system on behalf of the user.

19. A non-transitory computer-readable storage medium having instructions stored which, when executed by at least one processor, cause at least one processor to perform operations comprising:
receiving a plurality of available transactions from third party computing systems, wherein the plurality of available transactions require location verification;
displaying, via a display, the plurality of available transactions;
receiving a selection of an available transaction within the plurality of available transactions, the available transaction offered by a third party computing system within the third party computing systems;
executing location verification of a computing device, resulting in a verified location; and
initiating, after receiving the verified location, communications between the computing device and the third party computing system, the communications enabling fulfillment of the selection.

20. The non-transitory computer-readable storage medium of claim 19, having additional instructions stored which, when executed by at least one processor, cause the at least one processor to perform operations comprising:
transmitting, to the third party computing system, a request to log a user into the third party computing system;
receiving, via an API (Application Programming Interface) associated with the third party computing system, a login form;
transmitting, to the third party computing system, a completed login form; and
receiving, from the third party computing system, a token authorizing transactions on behalf of the user.
